(19) United States
(12) Patent Application Publication
(10) Pub. No.: US 2021/0098190 A1
(43) Pub. Date: Apr. 1, 2021

(54) METHOD FOR PRODUCING AN INSULATED SUPERCONDUCTING COIL, INSULATED SUPERCONDUCTING COIL, ELECTRIC MACHINE, AND HYBRID ELECTRIC AIRCRAFT

(71) Applicants: Matthias Corduan, Berlin (DE); Fabian Utzmann, Hallerndorf (DE)

(72) Inventors: Matthias Corduan, Berlin (DE); Fabian Utzmann, Hallerndorf (DE)

(21) Appl. No.: 17/031,173

(22) Filed: Sep. 24, 2020

(30) Foreign Application Priority Data
Sep. 30, 2019 (DE) 102019215019.5

(51) Int. Cl. H01F 41/04; H01F 41/12; H01F 6/06; B64D 27/24

(52) U.S. Cl. CPC H01F 41/048; B64D 27/24; H01F 6/06; H01F 41/125

(57) ABSTRACT

In the method for producing an insulated superconducting coil, a coil is wound, and the coil is subsequently provided with an insulation by a low-pressure plasma. The insulated superconducting coil is produced by such a method. The electric machine is, in particular, a motor and/or a generator and includes at least one such insulated superconducting coil. The hybrid electric aircraft includes at least one such electric machine.

The present patent document claims the benefit of German Patent Application No. 10 2019 215 019.5, filed Sep. 30, 2019, which is hereby incorporated by reference.

### TECHNICAL FIELD

The disclosure relates to a method for producing an insulated superconducting coil. The disclosure further relates to an insulated superconducting coil, an electric machine, and a hybrid electric aircraft.

### BACKGROUND

In energy technology, particularly in the case of electric machines for hybrid electric aircraft, superconductors may be used in a manner that increases efficiency. In particular, with superconductors, losses may be reduced and the power density may be increased. Superconductors are used particularly in direct current applications in electric machines. In principle, however, alternating current applications are also conceivable. However, alternating current applications cause great losses, for which reason superconductors have to be cooled to a greater extent in order to dissipate the heat loss. In particular, the electrical insulation of superconductors has to be taken into account here, because thick insulations hamper heat dissipation. In this regard, for instance, superconducting coils potted with resin are known. However, such coils cannot be used for alternating current applications on account of the poor heat dissipation capability.

In the case of superconductors which still have to be reacted in order that they may be used as superconducting coils, (e.g., in the case of magnesium diboride (MgB₂)), the minimum possible bending radius is greatly dependent on how the superconductor is intended to be reacted in the respective application. In particular, wind-and-react methods are known, wherein the coils are first wound, and the superconducting material of the coils is then reacted. Further, react-and-wind methods with the opposite order are known. During reaction, temperatures of up to 650° C. for time durations of approximately one hour are customary, which may destroy insulations of the coils.

In addition, wind-and-react methods cannot be associated with enamel insulations because, in the first place, after reaction the coils cannot be bent open again in order to apply an enamel insulation. An enamel insulation is likewise not possible before reaction, because the enamel insulation would not withstand the temperature during reaction.

### SUMMARY AND DESCRIPTION

Therefore, it is an object of the present disclosure to specify an improved method for producing an insulated superconducting coil which does not have the disadvantages mentioned above. In particular, the produced coil is configured to be used in alternating current applications. Furthermore, it is an object of the disclosure to provide an improved insulated superconducting coil, an improved electric machine, and also an improved hybrid electric aircraft.

The scope of the present disclosure is defined solely by the appended claims and is not affected to any degree by the statements within this summary. The present embodiments may obviate one or more of the drawbacks or limitations in the related art.

In the method for producing an insulated superconducting coil, a coil is wound and the coil is subsequently provided with an insulation by a low-pressure plasma. Low-pressure plasma is also known by the terms “cold” plasma and/or “non-thermal” plasma. Insofar as “provided with an insulation by low-pressure plasma” is mentioned in the context of the present application, this expression may be understood synonymously with the expressions and/or in combination with the expressions “provided with an insulation by plasma-enhanced vapor deposition” and/or “provided with an insulation by plasma polymerization”. Advantageously, in a low-pressure plasma, the gas temperature may be less than 100° C., and thus significantly less than a typical electron temperature of the superconductor, such that the superconducting material properties are maintained unchanged in the case of an insulation by a low-pressure plasma. Consequently, the low-pressure plasma provided does not adversely affect the superconducting properties of the coil. In addition, the method may be used particularly time-efficiently because insulations may be deposited particularly rapidly by low-pressure plasma. Furthermore advantageously, no environmentally harmful solvents are released in the course of the method. In other words, the method may be carried out in a solvent-free manner, such that statutory provisions, (e.g., of the German Federal Immission Control Ordinance (BImSchV)), may be complied with in a cost-effective and simple manner in the method. Furthermore, the method is inexpensive and simple on account of less use of material on account of possible small layer thicknesses and on account of short time expenditure for carrying out the method.

In particular, by the method, it is possible to provide the coil with an insulation in the form of a homogeneous layer. The layer thickness achieved by the low-pressure plasma has less variation than layer thicknesses of conventional insulations.

In contrast to known methods that use wet-chemical coating processes for insulation purposes, the method enables high gap penetration and edge coverage of the insulation, such that turns of the coil are advantageously able to be provided with an insulation completely, reliably, and uniformly. In contrast to conventional methods for producing insulated superconducting coils which realize insulations with liquid enamels, advantageously no wetting problems on account of a surface tension of the liquid enamel occur.

Provision with an insulation by low-pressure plasma according to the prior art may be effected analogously to the method disclosed in WO 2015/193030 A1. This document discloses plasma polymerization as an alternative to wet-chemical coating methods on electronic assemblies.

Advantageously, extremely small, highly reactive molecular building blocks may result in a layer structure by the method by low-pressure plasma. Insulations deposited precisely at low pressure in the form of layers have a very high degree of crosslinking, such that for a given insulation effect it is possible to realize very much smaller layer thicknesses than in conventional methods based on enameling. In addition, it is possible to avoid intrinsic layer stresses by the selection of the starting substance(s), process gas(ses), and/or process parameter(s). By virtue of the small layer thickness of the insulation, heat is readily able to be dissipated from the coil and, consequently, the coil may be used reliably even in alternating current applications.

Expediently, in the method, insulation is effected by a starting substance including at least one organosilicone compound, (e.g., hexamethyldisiloxane and/or vinyltrimethoxysilane and/or octamethylcyclotetrasiloxane), and/or a hydrocarbon precursor, (e.g., ethene and/or ethyne). Expediently, the starting substances are used in an adapted manner depending on superconducting coil and heat dissipation requirement. In this regard, the layer structure may be established both by the starting substance(s) and/or the process gas(ses) and by one or more process parameter(s), (e.g., a coating duration, a process pressure, an electrical power coupled in, a flow rate of a starting substance, a flow rate of a process gas, and/or a temperature when carrying out the method). Expediently, suitable starting substances and/or process parameters may be gathered from the literature, in particular, ISBN 978-0-323-13945-8. Particularly advantageously, insulation properties of the insulation and/or thermomechanical properties of the insulation are set in a suitable manner in this development of the method. By organosilicone compounds, (e.g., with the addition of oxygen), quartz-like insulation coatings may be deposited in the low-pressure plasma. Known hydrocarbon precursors such as ethene and/or ethyne make it possible to deposit insulations with a predefined insulation effect. In principle, a multiplicity of precursors are available because plasma-enhanced vapor deposition does not follow the reaction kinetics of wet-chemical polymerization. Instead, a great diversity of different layer-forming species that finally form the insulation are produced by energy input in the low-pressure plasma. In this development of the method, therefore, it is also possible to use starting substances which are not polymerizable wet-chemically.

In the method, the insulation may form a layer having an average thickness of at most 5 micrometers, of at most 3 micrometers, or of at most 1 micrometer. The method makes it possible to realize insulations with particularly homogeneous layer thicknesses. Consequently, a sufficiently high electrical insulation is already achievable with insulations in the form of layers having layer thicknesses of less than 1 micrometer. Advantageously, in this development of the method, the coils may be provided with a particularly small bending radius. Superconducting coils, (e.g., composed of MgB2), may be produced with a minimal bending radius given such small layer thicknesses of the insulation. In this case, the method is usable both as a wind-and-react method and as a react-and-wind method because organosilicone compounds, in particular, regularly have a melting point above the reaction temperature of MgB2. In addition, no temperature gradients that might damage the superconductor or adversely affect the superconducting properties thereof are introduced into the superconductor by the low-pressure plasma.

In the method, the insulation, alternatively or additionally, may form a layer having a maximum thickness of at most 5 micrometers, of at most 3 micrometers, or of at most 1 micrometer.

In the method, advantageously, an electrical power for generating the low-pressure plasma is provided by at least one electrode.

In the method, expediently, the at least one electrode or at least one of the plurality of electrodes is/are contacted with the coil in an electrically conductive, (e.g., touching), manner. In particular, in this development of the method, the electrical power for plasma generation at low pressure is coupled in capacitively via an electrode. Advantageously, the superconductor is in electrically conductive, (e.g., directly touching), contact with the at least one electrode. In this development, the superconductor itself functions as an electrode on account of its conductivity. During the process of provision with an insulation by low-pressure plasma, free charge carriers in the form of electrons accumulate at the at least one electrode, which form layer-forming molecules by momentum transfer. The electrode surface is thus the location with the highest deposition rate of an insulation. Consequently, the coil may already be provided with the insulation after no more than a few minutes, and with a homogeneous layer thickness. Optionally, and particularly advantageously, the coil is pretreated in the low-pressure plasma with regard to a surface of the coil for the method. In particular, in this development, the surface of the coil is activated by plasma etching, thus resulting in subsequent adhesion promotion of the insulation by covalent substrate bonding. Alternatively, or additionally, residues from manufacturing media and production that are possibly present may be cleaned from the surface of the coil in the low-pressure plasma. An additional outlay in terms of apparatus is not necessary for this purpose.

In the method, the electrical power is suitably coupled in capacitively by the at least one electrode.

In the method, the coil, (before it is provided with the insulation), is subjected to a thermal treatment by which the coil becomes superconducting. As already mentioned above, the thermal input owing to the low-pressure plasma is so low that the superconducting property of the coil is not necessarily adversely affected.

In the method, alternatively or additionally, the coil, (after it is provided with the insulation), may be subjected to a thermal treatment by which the coil becomes superconducting.

The insulated superconducting coil is produced by a method as described above.

The electric machine is, in particular, a motor and/or a generator and includes at least one insulated superconducting coil as described above. The electric machine, with the insulated superconducting coil, is advantageously able to be formed with a particularly high power density.

The hybrid electric aircraft includes at least one electric machine as described above. Advantageously, the electric machine has a particularly high power density, which is a particularly important parameter for operation in hybrid electric aircraft.

### BRIEF DESCRIPTION OF THE DRAWINGS

The disclosure will be discussed in more detail below on the basis of an exemplary embodiments illustrated in the drawings.

FIG. 1 depicts an example of a device for insulating a superconducting coil by a low-pressure plasma schematically in cross section.

FIG. 2 depicts an example of a hybrid electric aircraft schematically in a plan view.

### DETAILED DESCRIPTION

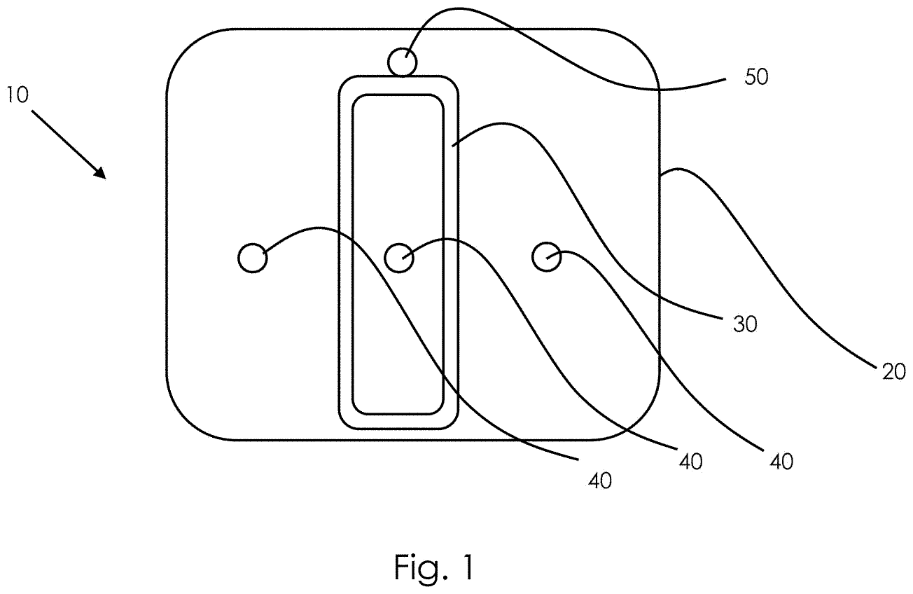

According to the disclosure, by the device 10 illustrated in FIG. 1, which forms a low-pressure plasma coating reactor, a wound superconducting coil 30 is provided with an insulation in a chamber 20 of the device. For this purpose, a superconducting coil 30 is used which has been wound in preceding acts of the method, the acts not being specifically described with reference to the drawing.

In the chamber 20 of the device 10, the coil 30 is provided with an insulation by a low-pressure plasma.

For this purpose, bar electrodes 40, 50 are present in the chamber 20 and provide an electrical power for generating the low-pressure plasma by virtue of the fact that they couple in the power capacitively. All the bar electrodes 40 are arranged within the coil 30 or outside the coil 30. A further bar electrode 50 bears against the coil 30 in an electrically conductive manner, such that the coil 30 and the other bar electrodes 40 are polarized differently. In principle, the further bar electrode 50 may also be contacted with the coil 30 by a conductive electrical connection.

A gas inlet is present (not specifically illustrated) within the chamber 20 of the device 10, by which inlet starting substances in the form of precursor gases pass into the chamber 20. The starting substances are organosilicone compounds, (such as hexamethyldisiloxane and vinyltrimethoxysilane and octamethylcycicotetrasiloxane), and/or hydrocarbon precursors, (for example, ethene and/or ethyne).

In the exemplary embodiment illustrated, an insulating layer having a maximum thickness of less than one micrometer is deposited on the coil 30 by the low-pressure plasma.

In the exemplary embodiment illustrated, the coil 30, (before it is provided with the insulation), has been subjected to a thermal treatment such that the coil 30 is superconducting. In alternative exemplary embodiments, it is also possible for the coil 30 to be subjected to a thermal treatment only after it has been provided with the insulation, by which thermal treatment the coil becomes superconducting.

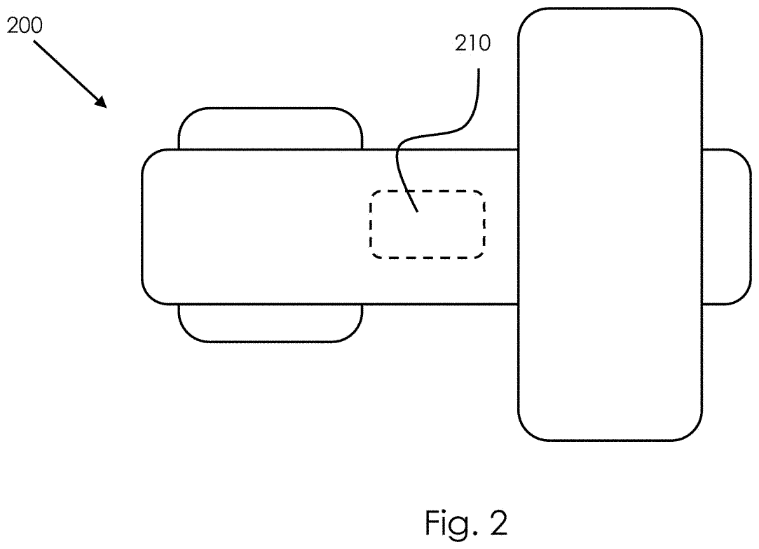

The hybrid electric aircraft 200 illustrated in FIG. 2 includes an electric machine 210 in the form of an electric motor formed with insulated superconducting coils 30. In principle, in further exemplary embodiments, not specifically illustrated, a generator may additionally be situated on board the hybrid electric aircraft 200, said generator likewise being formed with insulated superconducting coils 30.

Although the disclosure has been illustrated and described in greater detail by the exemplary embodiments, the disclosure is not restricted by these exemplary embodiments. Other variations may be derived herefrom by the person skilled in the art, without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for producing an insulated superconducting coil, the method comprising:
winding a coil; and
subsequently providing the coil with an insulation by a low-pressure plasma.

2. The method of claim 1, wherein insulation is effected by a starting substance comprising at least one organosilicone compound and/or a hydrocarbon precursor.

3. The method of claim 2, wherein the at least one organosilicone comprises hexamethyldisiloxane, vinyltrimethoxysilane, octamethylcyclotetrasiloxane, or a combination thereof.

4. The method of claim 3, wherein the hydrocarbon precursor comprises ethene, ethyne, or a combination thereof.

5. The method of claim 2, wherein the hydrocarbon precursor comprises ethene, ethyne, or a combination thereof.

6. The method of claim 1, wherein the insulation forms a layer having an average thickness of at most 5 micrometers.

7. The method of claim 1, wherein the insulation forms a layer having an average thickness of at most 3 micrometers.

8. The method of claim 1, wherein the insulation forms a layer having an average thickness of at most 1 micrometer.

9. The method of claim 1, wherein the insulation forms a layer having a maximum thickness of at most 5 micrometers.

10. The method of claim 1, wherein the insulation forms a layer having a maximum thickness of at most 3 micrometers.

11. The method of claim 1, wherein the insulation forms a layer having a maximum thickness of at most 1 micrometer.

12. The method of claim 1, further comprising:
supplying an electrical power for providing the low-pressure plasma by at least one electrode.

13. The method of claim 12, wherein the at least one electrode or at least one electrode of a plurality of electrodes is contacted with the coil in an electrically conductive manner.

14. The method of claim 13, wherein the electrically conductive manner comprises the at least one electrode touches the coil.

15. The method of claim 12, wherein the electrical power is coupled in capacitively by the at least one electrode.

16. The method of claim 1, further comprising:
subjecting the coil to a thermal treatment, before the coil is provided with the insulation, by which the coil becomes superconducting.

17. The method of claim 1, further comprising:
subjecting the coil to a thermal treatment, after the coil is provided with the insulation, by which the coil becomes superconducting.

18. An insulated superconducting coil comprising:
a wound coil; and
a low-pressure plasma deposited insulation covering the wound coil, the insulation effected by at least one organosilicone compound and/or a hydrocarbon precursor.

19. An electric machine comprising:
at least one insulated superconducting coil having:
a wound coil; and
a low-pressure plasma deposited insulation covering the wound coil, the insulation effected by at least one organosilicone compound and/or a hydrocarbon precursor,
wherein the electric machine is a motor and/or generator.

20. An electric aircraft comprising:
at least one electric machine having:
at least one insulated superconducting coil comprising:
a wound coil; and
a low-pressure plasma deposited insulation covering the wound coil, the insulation effected by at least one organosilicone compound and/or a hydrocarbon precursor,
wherein the electric machine is a motor and/or generator.
